(19) United States
(12) Patent Application Publication
(10) Pub. No.: US 2014/0337219 A1
(43) Pub. Date: Nov. 13, 2014

(54) SECURE DATA STORAGE AND TRANSACTION SYSTEM

(71) Applicant: Jonathan E. Ramaci, Isle of Palms, SC (US)

(72) Inventor: Jonathan E. Ramaci, Isle of Palms, SC (US)

(73) Assignee: BPHAV, LLC, Isle of Palms, SC (US)

(21) Appl. No.: 14/153,901

(22) Filed: Jan. 13, 2014

Related U.S. Application Data
(63) Continuation of application No. 13/892,815, filed on May 13, 2013, now abandoned.

(51) Int. Cl. G06Q 20/38; G06Q 20/32

(52) U.S. Cl. CPC G06Q 20/382; G06Q 20/322
USPC 705/44

(57) ABSTRACT

Embodiments of the invention are directed to a system, method, or computer program product for a transaction apparatus for secure data storage and consolidation of data for easy implementation and utilization during a transaction. The transaction apparatus may be configured, in various embodiments, for receiving, storing, encrypting, decrypting, encoding, decoding, accessing, transferring, writing, and/or presenting transaction data including, but not limited to, financial data, authentication data, identification data, health care data, access data, personal data, and/or other data associated with a user. As such, the transaction apparatus may receive data from a user and store the data. The user may then provide authorization to access the data. The user may then select the data to be copied to an output device associated with the apparatus. The output devices may include, but are not limited to, a writable transaction card, an E-ink display, the mobile device, and the like.

### BACKGROUND

Today, most individuals carry several financial items with him/her on a daily bases. Most individuals have multiple credit cards, debit cards, gift cards, coupons, loyalty cards, and/or the like that he/she carries. Along with the several financial items, individuals also carry identification items such as driver's license, identification cards, access cards, and the like on a daily bases. As such, most individuals end up carrying multiple items with him/her each time he/she goes anywhere.

These items, typically several of them, become cumbersome when an individual carries all of the items with him/her. Therefore these items are typically stored in a purse, wallet, pocket, or the like when the individual leaves his/her home. However, again, the purse, wallet, pocket, or the like may also become cumbersome based on the number of financial and/or identification items that an individual may accumulate and carry with him/her.

These financial and/or identification items are also important to the individual that is carrying the item. For example, the typical financial item may be associated with a financial account of the individual. An identification card may be associated with an individual's social security number, home, place of work, etc. However, rarely do individuals carrying these items secure them more than simply placing the items in his/her pocket or purse.

Therefore a need exists for a method and apparatus for the consolidation of the various financial and/or identification items in a secure manner.

### BRIEF SUMMARY

The following presents a simplified summary of all embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of all embodiments in a simplified form as a prelude to the more detailed description that is presented later.

Embodiments of the present invention address the above needs and/or achieve other advantages by providing apparatus (e.g., a system, computer program product, and/or other devices) and methods for secure data storage and the consolidation of financial and identification items for easy implementation and utilization during a transaction.

The transaction apparatus as described herein may be, in some embodiments, associated with a mobile device, such as being a case or attachment for a mobile device. In other embodiments, the transaction apparatus may be a standalone device. In yet other embodiments the transaction apparatus may be integrated into the mobile device. The transaction apparatus typically includes a processor and memory device. The transaction apparatus may be configured, in various embodiments, for receiving, storing, encrypting, decrypting, encoding, decoding, accessing, transferring, writing, and/or presenting transaction data including, but not limited to, financial data, authentication data, identification data, health care data, logical access, physical access, access data, personal data, and/or other data associated with a user. The financial data may be or include data such as credit and/or debit card data captured or input from a credit and/or debit card, account data such as demand deposit account (DDA) data such as checking account data, savings account data or data related to other types of accounts owned and/or associated with a user.

In some embodiments, the transaction apparatus may receive data by communication with a mobile device, by communication with a detachable magnetic strip reader (used to read, for example, a credit/debit card having a magnetic strip), by still photography or video capture (such as by image capture and decoding of a 2D or 3D barcode or by image capture and decoding, if necessary, of a check or other financial document), by accessing the Internet via a network, by communication with a biometric reader, by receiving manual input by a user, micro USB port, SIM cards, accessing a cloud, geo-fence, radio, vehicle, communication with other transaction apparatus, and/or the like. In some embodiments, the data received by the transaction apparatus may be determined to be associated with the user of the transaction apparatus, such that only data associated with the user and/or associated of the user may be stored in the transaction apparatus. In this way, individuals may not be able to receive and store other individual's financial information or the like without the other individual's knowledge. Communication with the mobile device may be through a direct hardwire connection or network connection such as a connection through a wireless network such as a cellular phone provider wireless data network, Wi-Fi, Bonjour, and/or the Internet, Near Field Communication (NFC) connection, Bluetooth® connection, Bluetooth® Lite connection, and/or the like. The detachable magnetic strip reader may attach to the transaction apparatus, the mobile device, or another device in communication with the transaction apparatus or mobile device. The attachment may, in some embodiments be though a hardwire connection such as through a USB port, micro-USB port, microphone port, other type of connector or the like, or through a wireless or hardline network connection.

In some embodiments, the data received may then be stored within the transaction apparatus. In some embodiments, the data may be stored in the transaction apparatus such that a mobile device or other device associated with the transaction apparatus may not have access to the data stored within the transaction apparatus. In some embodiments, the data may be stored in the transaction apparatus such that a mobile device or other device associated with the transaction apparatus may have limited access to the data stored within the transaction apparatus. The data stored within the transaction apparatus may be encrypted such that unwanted attempts to access the data may be denied. Furthermore, the data stored within the transaction apparatus may be protected because the connector(s) of the transaction apparatus are utilized by the processor such that PIN assignments differ from standard PIN assignments and, therefore, a peripheral attempting connection with the connector(s) of the transaction apparatus may not receive power from the expected PIN, may not be able to transfer data over expected PINs, and/or may be able to decode and/or decrypt data that stored and/or accessed from the transaction apparatus.

In some embodiments, a user of the transaction apparatus may access the data stored within the transaction apparatus. Prior to allowing access to all of the financial, identification, personal, and/or other data that is stored within the transaction apparatus, the user may be required to present authorization data to the transaction apparatus to ensure the user is authorized to access the data. The authorization data may be presented by the user to the mobile device, the transaction apparatus or a peripheral device, such as the magnetic strip reader or otherwise. The authorization data may include biometric data, such as fingerprint data captured by scanning a user's finger, retinal data captured by scanning a user's eye(s), etc., data corresponding to a user's PIN, shape or object recognition authorization, and the like. The authorization, if accepted, may allow a user to utilize the data stored within the transaction apparatus. However, in some embodiments, the data may only be utilized for specific tasks. For example, some and/or all of the data may not be communicated from transaction apparatus to the mobile device despite successful authorization of the user.

In some embodiments, the authentication for utilization of the data stored within the transaction apparatus may be unsuccessful. In this way, in some embodiments, the transaction apparatus may provide emergency contact information for the user, such that the person attempting to access the transaction apparatus and or mobile device of a user unsuccessfully may have the ability to communication with emergency contacts of the uses in case of an emergency. In other embodiments, the transaction apparatus may lock the transaction data stored within the transaction apparatus upon unsuccessful attempts to access the data. In yet other embodiments, the transaction apparatus may potentially erase the transaction data upon several unsuccessful access attempts.

The user may access and view portions of the data via his/her mobile device display utilizing an application or other program associated with the transaction apparatus. For example, if a user provided credit card data to the transaction apparatus, such as via the magnetic strip reader, the user may now be presented with a representation of some or all the credit card data via the application. The representation may include information that would be found on a typical credit card, such as an account number, name associated with the account, type of card, etc. However, the transaction apparatus may have also stored additional data captured from the magnetic strip on the credit card. Data such as a Card Verification Value (CVV1) code may be captured (or input by a user) to the transaction apparatus, and the transaction apparatus may not divulge (or may not immediately divulge) the CVV1 code to the mobile device, application and/or user. In this way, certain information may be stored within the transaction apparatus and not communicated to a mobile device or the like.

Accessing and viewing a representation of the data stored within the transaction apparatus on a display allows a user to select the financial, identification, personal and/or other data that the user may wish to use during a transaction. For example, the user may have multiple credit cards and/or debit cards that he/she may select when purchasing a product or service from a merchant. The user may select the one or more credit or debit cards that he/she may wish to use for the transaction.

Once the user selects the data from the display, the mobile device may present the selection to the transaction apparatus. The transaction apparatus will determine what data is stored in association with the user's selection and transfer that data to an output device.

In some embodiments, the transaction apparatus may present the selected data via an output device associated with the transaction apparatus. In this way, the output device may receive all data stored in the transaction apparatus associated with the selected financial account, identification, personal, access, heath care, or the like. Output devices may include, but are not limited to, a writable transaction card, E-ink display, wireless communications, micro-USB, Wi-Fi, geo-fence, communications with a cloud, television, radio, vehicle, other displays devices, and/or the like. In one example, the user may select financial account data associated with a debit card. The transaction apparatus may access the stored data associated with the debit card, such as, but not limited to, the card account number, security number, name associated with the account, expiration date, any other data stored on the magnetic strip, etc. The transaction apparatus may then communicate some or all the data to the writable transaction card associated with the transaction apparatus. As such, the writable transaction card may now be utilized as the debit card by the user for payments (or for withdrawals in some embodiments) at a merchant point of sale, ATM, bank, etc. In this way, the writable transaction card associated with the transaction apparatus may be used by the user in place of the debit card. In another example, the user may select loyalty account data associated with a merchant. The loyalty account data may have been captured from a photograph of a barcode and/or number associated with the loyalty account. The transaction apparatus may then build a graphic of the bar code and store the graphic in association with that loyalty account. Upon selection of the loyalty account data, the transaction apparatus may access the bar code information and/or graphic, merchant associated with the loyalty account, loyalty account number, etc. The transaction apparatus may then communicate some or all the data to an E-ink display or other display associated with the transaction apparatus. The user may utilize the bar code on the E-ink display in place of his/her loyalty account card.

Upon completion of a user utilizing the data for a transaction via an output device, the output device may be programmed to erase any or all data from its memory/magnetic strip/etc. and/or the transaction apparatus may time-out the output device if it is connected to the transaction apparatus. In this way, the data may be removed from the output device to prevent misuse of the data.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a high level process flow illustrating the process of using transaction apparatus, in accordance with embodiments of the invention;

FIG. 2 provides an embodiment of the transaction apparatus computing system, in accordance with an embodiment of the invention;

FIG. 3 provides an illustration of a process flow for a user set-up of the transaction apparatus in accordance with an embodiment of the invention;

FIG. 4 provides an illustration of a process flow for user utilization of the transaction apparatus for entering into a transaction, in accordance with an embodiment of the invention;

FIG. 5 provides a process map illustrating the process flow for of the system wake-up and utilization for a transaction after a user has set-up the transaction apparatus, in accordance with an embodiment of the invention;

FIG. 6 provides an illustration a front view of one embodiment of the transaction apparatus as a case associated with a mobile device, in accordance with an embodiment of the invention;

FIG. 7 provides an illustration of a front view of one embodiment of the removable upper portion of the transaction apparatus as a case associated with a mobile device, in accordance with embodiments of the invention;

FIG. 8 provides an illustration of a front view of one embodiment of the lower portion of the transaction apparatus as a case associated with a mobile device, in accordance with embodiments of the invention;

FIG. 9 provides an illustration of a front view of one embodiment of the lower portion of the transaction apparatus as a case associated with a mobile device with writable transaction card, in accordance with embodiments of the invention

FIG. 10 provides an illustration of a front view of one embodiment of the lower portion of the transaction apparatus as a case associated with a mobile device with the mobile device back protector hidden, in accordance with embodiments of the invention

FIG. 11 provides an illustration of a front view of one embodiment of the lower portion of the transaction apparatus as a case associated with a mobile device exposing a transaction card data transfer aperture, in accordance with embodiments of the invention;

FIG. 12 provides an illustration of a rear view of one embodiment of the transaction apparatus as a case associated with a mobile device, in accordance with embodiments of the invention;

FIG. 13 provides an illustration of a rear view of one embodiment of the transaction apparatus as a case associated with a mobile device with an E-ink display exposed, in accordance with embodiments of the invention; and

FIG. 14 provides an illustration of a rear view of one embodiment of the transaction apparatus as a case associated with a mobile device with the transaction apparatus board exposed, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the term “transaction” as used herein may include any financial transaction, such as a purchase, payment, ATM transaction, and the like; loyalty account usage; redemption, such as redemption of a gift card, coupon, and the like; identification interaction, such as a driver's license, identification card, and the like; logical access, such as restricted electronic file access and the like; physical access, such as restricted rooms access and the like; heath care information access; and/or other exchange of information from one party to another.

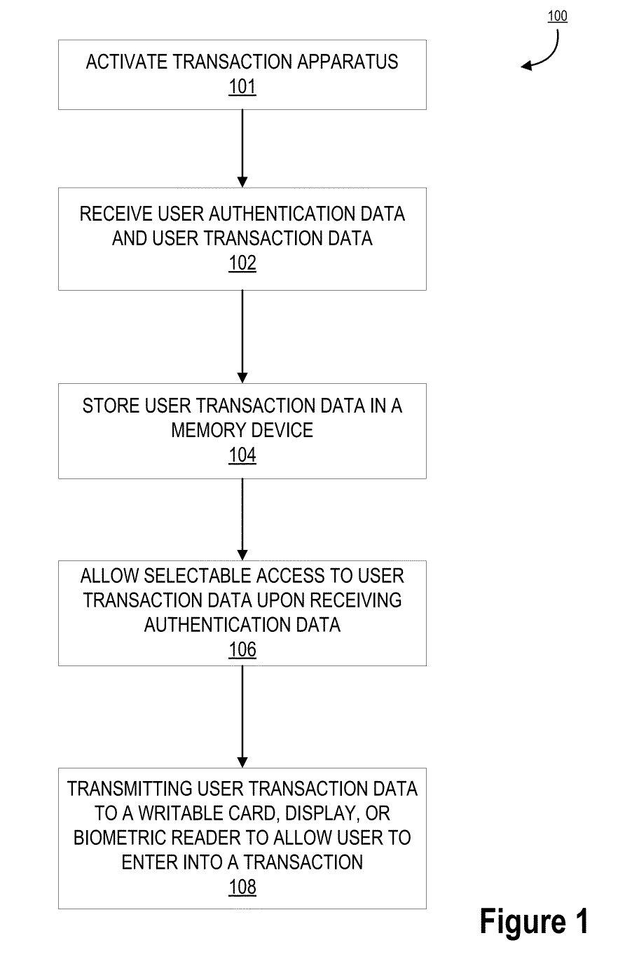

FIG. 1 illustrates a high level process flow of using the transaction apparatus 100. As illustrated in block 101 the transaction apparatus may be activated. Activating the transaction apparatus may, in some embodiments, include connecting the apparatus to a mobile device. In other embodiments, if the transaction apparatus is a standalone device, the device may simply need to be powered on via a battery, rechargeable cell, or the like. In other embodiments, opening an application associated with the transaction apparatus may activate the transaction apparatus. Once connected to a mobile device activation of the transaction apparatus may include downloading an application on his/her mobile device. The application may allow for a communication interface between the apparatus and the mobile device.

Next, as illustrated in block 102 the transaction apparatus may receive user authentication data and/or user transaction data. In some embodiments, the transaction apparatus may receive data by communication with a mobile device, a detachable magnetic card reader, photography, accessing the Internet via a network, biometric reader, manual input by a user, a Subscriber Identification Module (SIM) card, and the like. The communication with a mobile device may be through a direct hardwire connection, micro-Universal Serial Bus (USB) connection, Wi-Fi connection, cloud connections, Bonjour connection, Near Field Communication (NFC), Bluetooth®, Bluetooth® Lite, other network connections, etc. The detachable magnetic card reader may attach to the transaction apparatus, the mobile device, or another device in communication with the transaction apparatus or mobile device. The attachment may, in some embodiments, be made through a hardwire connection such as through a USB port, microphone port, etc. or a network connection. User authentication data may include unique user identifiers such as biometric scan data, such as finger print scanning, retinal scanning, etc., PINs, PIN authorization, shape or object recognition, passwords, and the like. User transaction data may include, but is not limited to financial data, identification data, health care data, and/or other personal data. Financial data includes data associated with demand deposit accounts (DDAs) such as credit card accounts, debit card accounts, gift cards, loyalty accounts, savings account, checking accounts, line of credit accounts, etc. Identification data may include insurance cards, identification cards, driver's license, social security cards, passports, business cards, etc. Health care data may include, but is not limited to medical records, prescriptions associated with a user, medical history, allergy information, etc.

As illustrated in block 104, the transaction apparatus may receive user authentication data and/or user transaction data. In some embodiments, the transaction apparatus may receive data by communication with a mobile device, a detachable magnetic card reader, photography, accessing the Internet via a network, biometric reader, manual input by a user, a Subscriber Identification Module (SIM) card, and the like. The communication with a mobile device may be through a direct hardwire connection, micro-Universal Serial Bus (USB) connection, Wi-Fi connection, cloud connections, Bonjour connection, Near Field Communication (NFC), Bluetooth®, Bluetooth® Lite, other network connections, etc. The detachable magnetic card reader may attach to the transaction apparatus, the mobile device, or another device in communication with the transaction apparatus or mobile device. The attachment may, in some embodiments, be made through a hardwire connection such as through a USB port, microphone port, etc. or a network connection. User authentication data may include unique user identifiers such as biometric scan data, such as finger print scanning, retinal scanning, etc., PINs, PIN authorization, shape or object recognition, passwords, and the like.

Next, as illustrated in 106 the transaction apparatus allows selectable access to the user transaction data. Prior to allowing selectable access to the user, the user may be required to present authorization data to the transaction apparatus to ensure the user is authorized to access the data. For example, the user may have provided authentication data in the form of a finger print scan in block 102. The user may now produce the same finger print scan in block 106 in order to allow the user access to the data. The authorization data may be presented by the user to the mobile device or the transaction apparatus. The authorization data may include data captured by biometric scanning, such as finger print scanning, retinal scanning, etc., PIN authorization, shape or object recognition authorization, and the like. The authorization, if accepted, may allow a user to utilize the data stored within the transaction apparatus. This provides security protection to a user's personal financial and/or identification data, thus ensuring that the user is the only person able to access the data.

Finally, once the user selects the transaction data, the transaction apparatus may transmit the user transaction data to an output device such as a writable transaction card, E-ink display, or biometric authentication device to allow the user to enter into a transaction, as illustrated in block 108. In this way, the output device may receive all data stored in the transaction apparatus associated with the selected transaction data and present the selected transaction data such that the user may utilize the transaction data to utilize for a transaction.

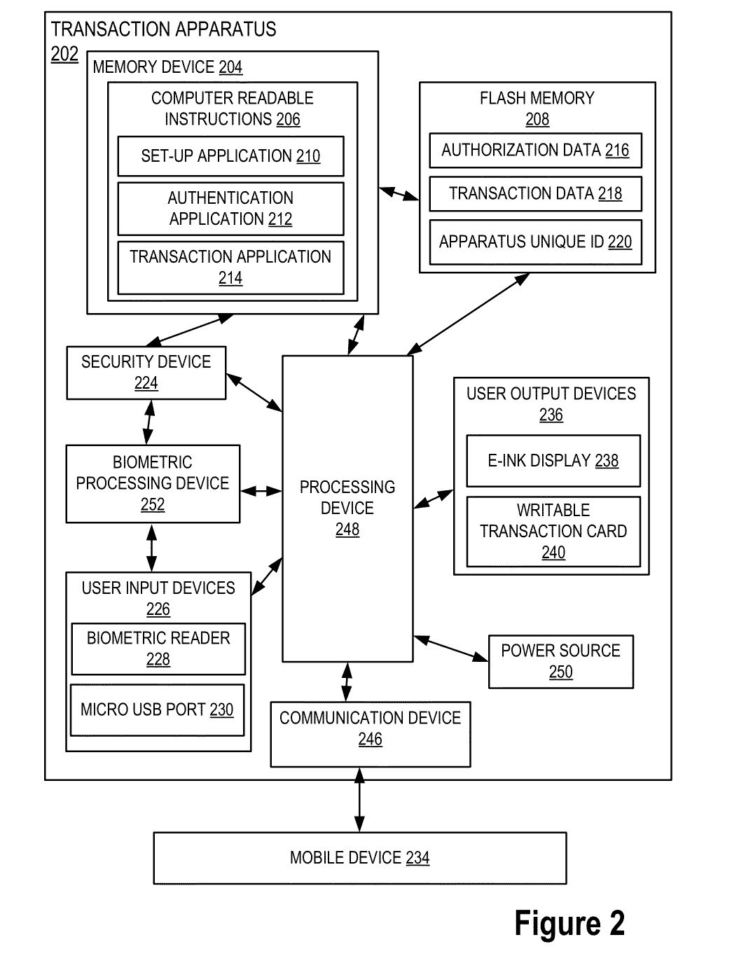

FIG. 2 illustrates an embodiment of the transaction apparatus computing system, in accordance with an embodiment of the invention. In some embodiments, when the transaction apparatus 202 is associated with a mobile device 234, the mobile device 234 is in communication with the transaction apparatus 202.

The mobile device 234 may be any communication device, including tablet devices, cellular telephones, personal digital assistant (PDA), a mobile Internet accessing device, or other user system including, but not limited to, pagers, televisions, gaming devices, laptop computers, desktop computers, cameras, video recorders, audio/video player, radio, GPS devices, any combination of the aforementioned, or the like. In some embodiments, a mobile device 234 includes a communication device, a processing device, and a memory device. The processing device is operatively coupled to the communication device and the memory device. The processing device uses the communication device to communicate with the transaction apparatus 202 and other devices. Furthermore, communication between the mobile device 234 and the transaction apparatus 202 may be commanded through the use of an application that may be operated by a user via a display associated with the mobile device 234.

The mobile device 234 may include computer-readable and executable instructions stored in the memory device, which in one embodiment may include computer-readable instructions structured as an application for causing the processor to initiate user viewing, user selection, and control of operations associated with the transaction apparatus. In some embodiments, the memory device includes data storage for storing data related to the mobile device including but not limited to data associated with the application for operating the transaction apparatus 202.

The transaction apparatus 202 generally comprises one or more processing devices. In some embodiments, only one processing device is necessary for the transaction apparatus 202. In yet other embodiments, two or more processing devices are necessary for the transaction apparatus 202. The transaction apparatus 202 illustrated in FIG. 2 has two processing devices: a transaction apparatus processing device 248 and a biometric processing device 252. The transaction apparatus 202 also includes one or more of memory device 204, flash memory 208, a security device 224, user input devices 226, user output devices 236, and optionally a power source 250.

The user input devices 226 allow a user to input transaction data and/or authorization data onto the flash memory 208 of the transaction apparatus 202. In some embodiments, a user input device 226 may include a biometric reader 228. The biometric reader 228, whether utilized for finger print providing, retinal scanning, and or the like may provide the flash memory 208 with authorization data 216 captured from a user desiring access to the transaction apparatus 202. In some embodiments, a user input device 226 may include a micro USB port 230. The micro USB port 230 allows the transaction apparatus 202 to be connected to a data reader device in order to receive data read from a user device such as a magnetic strip card data via a magnetic strip reader. In this way, the micro USB port 230 may provide the flash memory with transaction data 218 such as data read from a card having a magnetic strip or the like. Furthermore, a user may utilize his/her mobile device 234 to input data to be stored in the flash memory 208. In some embodiments, user input devices 226 may include several other input devices or input connection capabilities, such as, but not limited to SIM cards, Wi-Fi connections, Bonjour connections, cloud connection, television connections, radio connections, vehicle connections, etc.

The flash memory 208 stores the authorization data 216, the transaction data 218, and the transaction apparatus unique ID 220. Authorization data 216 may include biometric scanning data, such as finger print scanning data, retinal scanning data, etc., PIN authorization, shape or object recognition authorization, and the like. Transaction data 218 may include financial data, personal data, heath care data, and/or identification data. In some embodiments the apparatus unique ID 220 is an identification that is unique to each individual transaction apparatus 202. In some embodiments, the apparatus unique ID 220 of the mobile device is compared to the apparatus unique ID 220 stored in the transaction apparatus 202 each time an application is opened by the mobile device that requests access to, or operation of, the transaction apparatus 202. In this way, a user may not be able to take another user's transaction apparatus, connect his/her mobile device such that he/she may be able to gain access to another individual's transaction data. In other embodiments, the apparatus unique ID 220 is confirmed when the mobile device is first connected with the transaction apparatus. In this way, the confirmation steps may only need to be performed once while the transaction apparatus and the mobile device remain connected. In other embodiments, the confirmation occurs based on a predetermined list of actions taken by the mobile device application, such as when the mobile device application requests access to generally inaccessible data. In some such embodiments, the transaction apparatus also confirm the identity of the user by biometric authentication or otherwise.

The power source 250 of the transaction apparatus 202 may be, in some embodiments, drawn from the mobile device 234. For example, prior to opening an application to operate the transaction apparatus 202 the transaction apparatus 202 may pull less than five milliamps from the mobile device 234. However, upon activation, the transaction apparatus 202 may draw more power from the mobile device 234. In some embodiments, the transaction apparatus 202 may comprise its own power source 250. In this way, the transaction apparatus may comprise a rechargeable battery or the like in order to power the system. In yet other embodiments, the power source 250 may include kinetic energy charging, solar power, wireless charging, wireless power, and/or the like. Furthermore, the transaction apparatus 202 may charge both the writable transaction card 240 and/or the mobile device 234.

The security device 224 communicates between the processing device 248, the biometric processing device 252, and the memory device 204. During the process of using the transaction apparatus 202 there are several security checks, such as a user authentication, apparatus unique ID, and/or the like. As such, at each check, if the authentication does not match correctly, the biometric processing device 252 may communicate with the security device 224 to provide a security feature to whomever is attempting to access the transaction apparatus 202. In some embodiments, the security device 224 may temporarily lock out the transaction data such that the attempted user may not be able to access the data if he/she (or the device) is not authenticated. In other embodiments, upon several failed authentication attempts the transaction apparatus 202 may present the authenticated user's emergency contact information. In this way, if the user and/or another individual whom is attempting to access the transaction apparatus 202 but is unsuccessful may receive emergency contact information to the attempted user. In yet other embodiments, the transaction apparatus 202 may erase the flash memory of the transaction apparatus 202. In this way, the security device 224 may completely erase the transaction data 218 such that other individuals may not be able to access the transaction data 218 of the user.

As illustrated, the transaction apparatus 202 comprises a general processing device 248 and a biometric processing device 252. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. In some embodiments a processor may comprise one or more peripheral interface controllers associated therein. A processing device may include functionality to operate one or more software programs based on computer-readable instructions thereof, which may be stored in a memory device.

The biometric processing device 252 is associated with the user input devices 226 and the communication device 246 to determine if the user attempting to access the data on the transaction apparatus 202 is authorized to do so. The biometric processing device 252 provides for multiple authentication checks. The biometric processing device 252 may match the apparatus unique ID 220 between a mobile device and the transaction apparatus and the biometric processing device 252 may also match authorization data from a user input device 226 with authorization data 216 stored in the flash memory 202. These security features ensure that the user who is attempting to access the transaction data of a user. First, the biometric processing device 252 upon receiving an indication that the application associated with operating and user command for operating the transaction apparatus 202, will provide a security check for the apparatus unique ID 220 with the mobile device 234 operating system. In other words, the biometric processing device 252 compares the apparatus unique ID 220 corresponding to the mobile device 234 with the apparatus unique ID 220 stored in the transaction apparatus 202. Second, the biometric processing device may communicate with user input devices 226 to receive authentication data 216 from a user input device 226 such as a biometric reader 228. Upon receiving the authorization data from the user input device the biometric reader 228 may attempt to match the authorization data received to the authorization data 216 stored in the flash memory 208. If one of these authorization steps performed by the biometric processing device 252 does not match, the biometric processing device 252 communicates with the security device 224 to ensure the correct security feature is provided, such as locking out the data, providing emergency contact information, or erasing the data in the flash memory 208. If, however, the biometric processing device 252 determines that authentication has been matched, the system may allow the user to continue the process of accessing the user transaction data to present to an output device 236.

The processing device 248 is operatively coupled to the communication device, the memory device 204, flash memory 208, the biometric processing device 252, user input devices 226, and user output devices 236. The processing device 248 uses the communication device 246 to communicate with a mobile device 234. As such, the communication device 246 generally comprises a modem, server, or other device for communicating with the mobile device 234 and other devices.

The communication device allows for communication between the transaction apparatus 202 and a mobile device 234. In some embodiments this communication may be a direct hardwire connection between the transaction apparatus 202 and the mobile device 234. In other embodiments, the communication may be via network connection such as through NFC, Wi-Fi, Bluetooth®, Bluetooth® Lite, cloud communication, radio, and/or the like. When an application that communicates with the transaction apparatus 202 is opened on the user's mobile device 234 an operating system session is opened. Prior to any utilization of the transaction apparatus 202 when it is associated with a mobile device 234, there is an authentication between a processor associated with the mobile device 234 and the transaction apparatus 202. Once this authentication has been completed the transaction apparatus 202 using the communication device 246 is able to communicate with the mobile device 234 using the mobile device 234 operating system protocol.

As further illustrated in FIG. 2 the transaction apparatus comprises user output devices 236. These user output devices 236 are utilized to present transaction data to a second party, such as a merchant, point of transaction, access location, etc. The output devices 236 include an E-ink display 238, a writable transaction card 240, wireless communication, hardwire communication, Wi-Fi, NFC, geo-fence, micro-USB port, Bonjour networks, cloud communication, television, radio, vehicle, etc.

The E-ink display 238 may present 1D bar code, 2D bar code such as a QR code, coupon, identification information, advertisements, skew numbers, micro-bulletin boards, the unique transaction apparatus ID 220, color data, mobile device data, such as, but not limited to data lists, text messages, stock ticker information, games, emails, and/or the like on the transaction apparatus 202. In this way, the user may be able to present transaction data on the E-ink display 238 in preparation for or during a transaction. For example, typical loyalty cards are scanned at a point of sale using a standard bar code scanner. The standard bar code scanner may not be able to recognize bar codes that are produced on a backlit screen, such as those found in most cellular phones, tablet computers, lap top computers, and the like. Accordingly, if a loyalty card is reproduced on one of these backlit screens, the point of sale bar code scanner will not be able to read the bar code effectively. The transaction apparatus 202 may provide the user with an E-ink display 238 that provides a dull ink like finish to a separate display associated with the transaction apparatus 202. Therefore a typical bar code scanner may be able to scan the E-ink display in order to scan the information associated with transaction data that is in a form scan-friendly form.

The writable transaction card 240 may present some or all the transaction data stored in flash memory 208 by incorporating the data in a format useful for presentation to a second party. The data, that was originally captured from a magnetic strip, such as from a credit card, debit card, gift card, some loyalty cards, and the like, may be presented in a similar fashion as it was originally stored in the user device or it may be incorporated in a different format. Upon user selection, the writable transaction card 240 may communicate with the processing device 248 such that transaction data associated with a particular credit card may be transferred to the writable transaction card 240. In this way, the writable transaction card 240 may now be utilized as the credit card for any transactions. For example, if a user is wishing to make a purchase at a gas station, the user may select his/her credit card associated with that gas station, for example, by selecting the credit card via the user interface provided by the mobile device associated with the transaction apparatus. As a specific example, the user may select an image of that credit card from an application. The transaction apparatus 202 may then receive the user's request and retrieve the transaction data 218 associated with the selected credit card. At that point, the processing device 248, through a contact connection for example, will communicate the transaction data 218 associated with the selected credit card, including magnetic strip data, account holder information, account number, etc. to the writable transaction card 240. In this way, the writable transaction card 240 may act as the credit card associated with the gas station without the user having to carry the credit card associated with the gas station. Instead, each credit card associated with a user's accounts may be stored in the flash memory 208, such that any credit card, debit card, etc. may be written onto the writable transaction card 240. The processing device 248 may also write a time-out to the writable transaction card 240 such that the writable transaction card 240 may erase once the user has used the transaction card 240.

As further illustrated in FIG. 2, the transaction apparatus 202 comprises computer-readable instructions 206 stored in a memory device 204, which in one embodiment includes the computer-readable instructions 206 of a set-up application 210, an authentication application 212, and a transaction application 214. In some embodiments, the memory device 206 includes data storage for storing data related to the set-up application 210, an authentication application 212, and a transaction application 214.

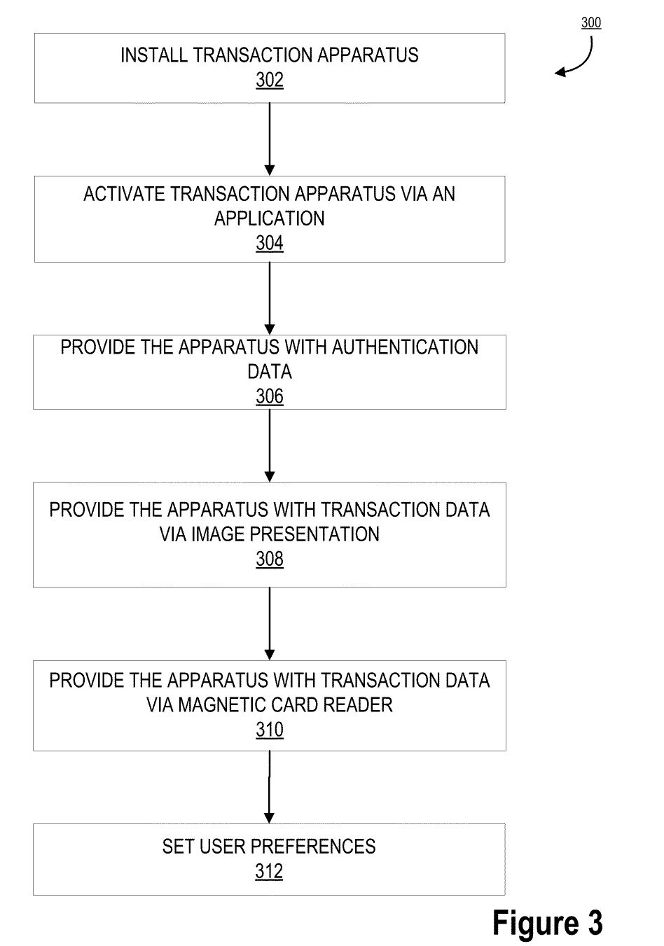

In some embodiments, as described in more detail below in FIG. 3, the set-up application 210 allows for initiation and set up of the transaction apparatus 202 as well as the input of data into flash memory 208. The set-up application 210 allows for set-up of the transaction apparatus 202 including the receiving of transaction data and authorization data as well as the storing of the same.

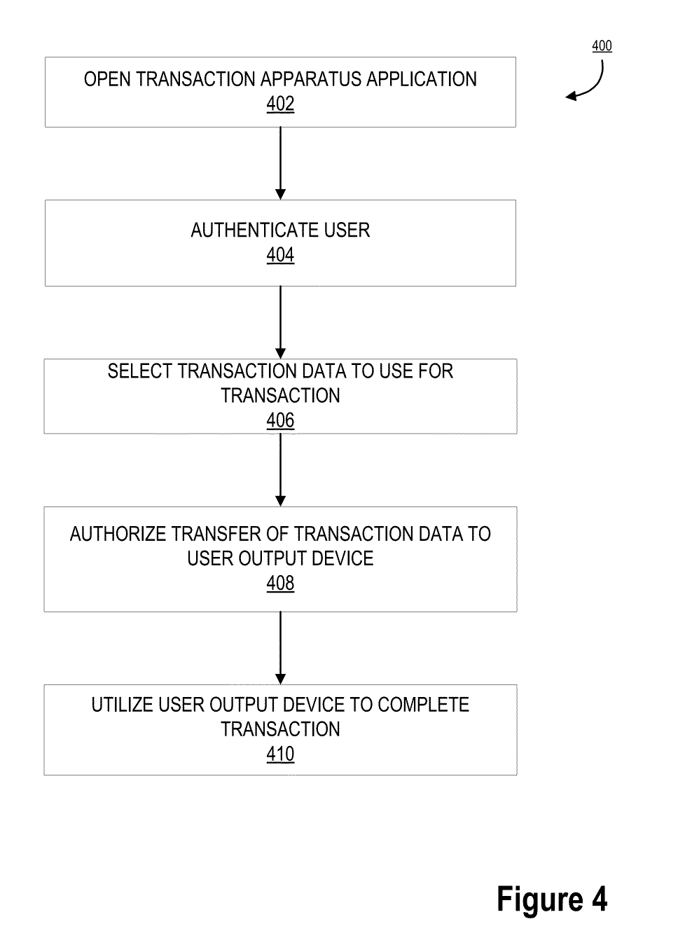

In some embodiments, as described in more detail below in FIG. 4, the authentication application 212 authenticates the mobile device 234 communication with the transaction apparatus 202 and authenticates the user for use of the transaction apparatus 202.

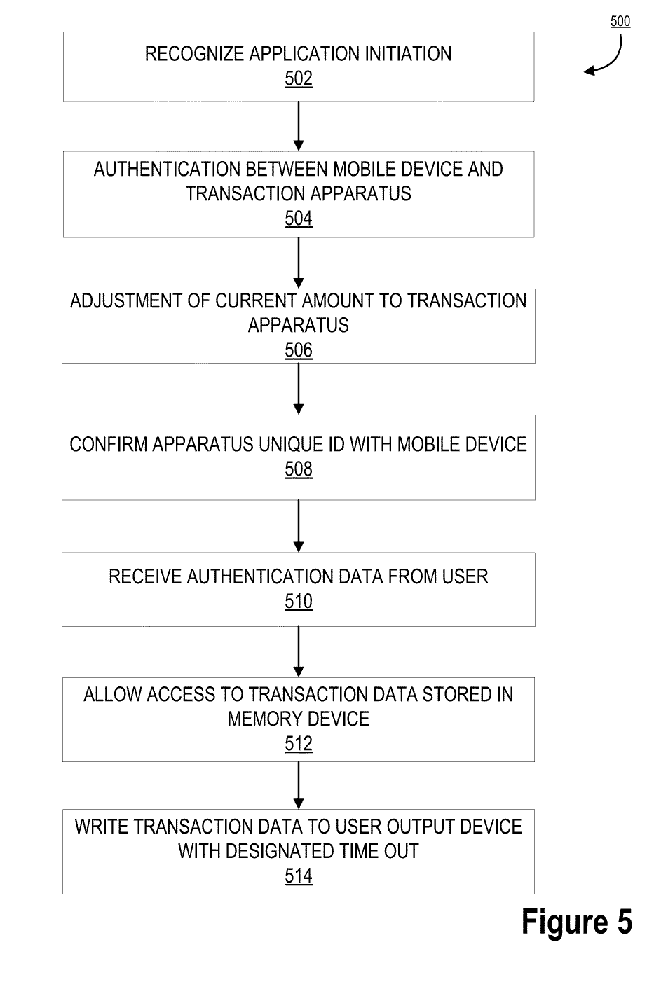

In some embodiments, as described in more detail below in FIG. 5, the transaction application 214 allows for user access to a limited amount of transaction data, user selection of the transaction data for use during a transaction, the transferring of transaction data to an output device 236, and/or in some embodiments, the presentment of transaction data on the output device 236.

It is understood that the servers, systems, and devices described herein illustrate one embodiment of the invention. It is further understood that one or more of the servers, systems, and devices can be combined in other embodiments and still function in the same or similar way as the embodiments described herein. Furthermore, one or more of the components, devices, systems, etc. discussed herein may be optional and may not be included in various embodiments of the invention.

FIG. 3 illustrates a process flow for a user set-up of the transaction apparatus 300, in accordance with an embodiment of the invention. As illustrated in block 302, the transaction apparatus may be installed. In some embodiments, the transaction apparatus may be associated with a mobile device. In other embodiments, the transaction apparatus may be a standalone device. In some embodiments of the invention, the installation of the transaction apparatus may require a hardwire or wireless connection to a mobile device.

As further illustrated in FIG. 3, the process of setting up the transaction apparatus may further include activating the transaction apparatus via an application, as illustrated in block 304. The activation of the application may be done via accessing and/or downloading of an application associated with the transaction apparatus. The application may allow for user utilization of the transaction apparatus whether for receiving, storing, encrypting, decrypting, encoding, decoding, accessing, transferring, writing, and/or presenting transaction data. In this way, the application (or user interface) may allow a user to communicate with the transaction apparatus in order to perform transaction apparatus functions.

Next, as illustrated in block 306, the user may provide the transaction apparatus with authentication data. Authorization data may include but is not limited to biometric data, such as fingerprint data captured by scanning a user's finger, retinal data captured by scanning a user's eye(s), etc., data corresponding to a user's PIN, shape or object recognition authorization, and/or any other data that may be unique to the user.

The user may upon activation of the transaction apparatus in block 304 provide the transaction apparatus with authentication data in several ways. The user may provide the transaction apparatus with authentication data utilizing communications with a mobile device, a detachable magnetic strip reader, by still photography or video capture, Internet access via a network, a biometric reader, by receiving manual input by a user, micro USB port, SIM card access, accessing a cloud, geo-fence, radio, vehicle, communication with other transaction apparatus, and/or the like.

In some embodiments, the application may prompt the user to provide specific authentication data. In other embodiments, the user may select which authentication data to provide. For example, the user may select to utilize a finger print scanner for authorization. Furthermore, the user may be able to select which finger from which hand the user may wish to utilize for authentication.

In some embodiments, the user may also provide transaction data. In some embodiments, the user may provide transaction data simultaneously with authentication data. In some embodiments, the user may provide transaction data prior to providing the authentication data. In yet other embodiments, the user may provide transaction data after providing the authentication data. In some embodiments, the user may provide transaction data in several ways, including the ways the user presents authentication data, as described above. These ways may include, but are not limited to utilizing communications with a mobile device, a detachable magnetic card reader (magnetic strip reader), by image presentation (such as still photography or video capture), Internet access via a network, manual input, a biometric reader, by receiving manual input by a user, micro USB port, SIM card access, accessing a cloud, pulling data, bump, inferred, geo-fence, radio, vehicle, communication with other transaction apparatus, and/or the like.

In some embodiments, the transaction data provided to the transaction apparatus may be determined, by the transaction apparatus, to be associated with the user of the transaction apparatus. In this way, based on the authentication data, the transaction data received at the transaction apparatus may only be associated with the user and/or user associates. Thus, transaction data not associated with the user of the transaction apparatus may not be stored in the transaction apparatus. As such, an individual may not be able store another individual's transaction data without his/her permission.

As discussed in further detail above, there are several ways to provide transaction data. However, in the illustration of FIG. 3 the transaction data may be provided to the transaction apparatus via image presentation in block 308 and via magnetic card reader in block 310.

As illustrated in block 308, the apparatus may be provided with transaction data via image presentation. Image presentation may be done by still photography, video capture, inferred, laser reading, scanning, Internet communication, and/or the like. Utilizing still photography or video capture the transaction apparatus may capture and decode data associated with a 1D, 2D, or 3D barcode, financial document, coupon, identification document, and/or the like. Capturing the still photography or video may, in some embodiments, be performed by the transaction apparatus. In some embodiments, the still photography or video may be captured by the mobile device. In other embodiments, the still photography or video may be captured by another device that is associated with the transaction apparatus. The transaction apparatus may also be able to decode data associated with QR codes, checks, images on cards, such as payment cards, identification cards, healthcare data, x-rays, etc.

As illustrated in block 310 the user may provide the apparatus with transaction data via a magnetic strip card reader. The magnetic strip reader may be associated with the transaction application. In some embodiments, the magnetic strip reader may be integrated into the transaction apparatus. In some embodiments, the magnetic strip reader may be an attachment to the transaction apparatus. The magnetic strip reader may attach to the transaction application using micro-USB, Bluetooth®, Bluetooth® Lite, Wi-Fi, NFC, and/or the like. The magnetic strip card reader may communicate with the transaction apparatus to provide the transaction apparatus with data associated with a magnetic card. The magnetic card may comprise user financial data, identification data, healthcare data, personal data, etc. The user may use the magnetic card reader to obtain information that would be found on a typical magnetic card, such as an account number, name associated with the account, type of card, user personal identification information, healthcare data, etc. Furthermore, data such as a Card Verification Value (CVV1) code stored in the magnetic strip of a card may be captured to the transaction apparatus, and the transaction apparatus may not divulge (or may not immediately divulge) the CVV1 code to the mobile device, application and/or user. In this way, certain information may be stored within the transaction apparatus and not communicated to a mobile device or the like. The provided transaction data may be required to match the user and/or the user's associates. In this way, a transaction apparatus may not receive transaction information associated with a different individual, but instead the transaction data received may be associated with the user and/or his/her associates.

Next, as illustrated in block 312, the user is able to set preferences within the application for the utilization of data by the transaction apparatus using an output device associated with the same. Preferences may include, but are not limited to the user being able to time-in and/or time-out the data on an output device. In this way, when the data is transmitted from the transaction apparatus to an output device such as a writable transaction card, the data may only exist on the output device for a specific amount of time before the data is erased from the output device. Preferences may also include, but are not limited to application design preferences, data access preferences, set the track to write data to on the writable transaction card, data organization preferences, and/or the like.

FIG. 4 illustrates a process flow for user utilization of the transaction apparatus for entering into a transaction 400, in accordance with an embodiment of the invention. As illustrated in block 402 the user may open the transaction apparatus application. The application may be associated with a mobile device and/or the transaction apparatus. The application may then communicate with the transaction apparatus to initiate a session with the transaction apparatus. Whether the session is for receiving, storing, encrypting, decrypting, encoding, decoding, accessing, transferring, writing, and/or presenting transaction data using the transaction apparatus, the session may be initiated by the user opening the application.

The user may then, as illustrated in block 404, be authenticated. In some embodiments, the user may provide authentication via a biometric reader associated with the transaction apparatus. As such, the user may swipe his/her finger on a biometric reader associated with the transaction apparatus in order to be authenticated. The finger print scan of a user may match previously provided authentication data that the transaction apparatus received. If the authentication is a match, the application presents the user with options for selecting transaction data to use for a transaction, as represented by block 406. However, if the user authentication is not a match to the authentication data previously presented to the transaction apparatus, the transaction apparatus, via the application, may provide emergency contacts for the user, lock out the user, or erase the transaction data stored within the transaction device.

As illustrated in block 406, the user, using the application, may select the transaction data he/she wishes to use for a transaction. For example, a user may be wishing to transact with a merchant. The user may wish to use his/her Visa® credit card for the transaction. As such, the user may select, via the apparatus, the Visa® credit card data stored within the transaction apparatus.

Once the user has selected the transaction data in the transaction apparatus that he/she wishes to use for a transaction (such as the Visa® as in the example above) the user may authorize the transfer of that transaction data to a user output device, as illustrated in block 408. The data may be transferred to one or more output devices, such as an E-ink reader, a writable transaction card, Wi-Fi, Bluetooth, Bluetooth Lite, etc. For example, a user may select to use the writeable transaction card. The data may be transferred to the writable transaction card via an EMV chip or the like on the chip to transfer via a contact transfer, data from a transaction apparatus to a writable transaction card. The transfer of transaction data may also include time-out data, such that the data may be erased from an output device after a predetermined amount of time.

Finally, as illustrated in block 410 the user may utilize the output device to complete the transaction. For example, the user may be able to present identification, a loyalty card, and/or the like via the E-ink display. In another example, a user may be able to present his/her credit card, debit card, heath care insurance card, etc. via the writeable transaction card. In this way, the writable transaction card includes all data associated with the credit card, debit card, heath care insurance card, etc. such that the user may provide the writable transaction card as a replacement for the credit card, debit card, heath care insurance card, etc.

FIG. 5 illustrates a method 500 for the process of the system wake-up and utilization for a transaction after a user has set-up the transaction apparatus, in accordance with an embodiment of the invention. The transaction apparatus may wake-up upon recognition of application initiation 502. As described in further detail above, the user may activate an application that may communicate with and provide commands to the transaction apparatus and the transaction apparatus system therein. The activation of the application initiates an Operating System (OS) session.

Once the OS session has been initiated a chip associated with the mobile device may communicate with the transaction apparatus. This communication may, as illustrated in block 504, be an authentication between the mobile device and the transaction apparatus to ensure connection and that the user wishes to utilize the transaction apparatus for a transaction.

Next, as illustrated in block 506, once the mobile device and the transaction apparatus have authenticated, there is an adjustment of the amount of current being directed to the transaction apparatus. In some embodiments, the source of this current may be the transaction apparatus itself. In other embodiments, the source for this current may be a mobile device associated with the transaction apparatus. In yet other embodiments, the transaction apparatus may draw current from a wireless network or the like. Prior to the initiation of the application and the authentication of the mobile device with the transaction apparatus, the transaction apparatus may pull no more than five milliamps of power from a power source. However, once the application has been initiated, the transaction apparatus is able to pull as much power from a source as necessary to complete the functions it is asked to do.

Block 508 of FIG. 5 illustrates that a confirmation of the transaction apparatus unique ID with the mobile device may occur next, after power to the transaction apparatus has been adjusted. In some embodiments, the authentication at this point may be a quick communication of the transaction apparatus unique ID. This authorization process may occur quickly, within seconds or fractions of a second, without user knowledge of the authentication. This authentication is to ensure that the user has used the currently associated mobile device in conjunction with the transaction apparatus in the past. For example, if an individual attempts to steal a user's transaction apparatus and attempts to activate it using his/her own mobile device (in order to obtain transaction data from the user) the apparatus unique IDs of the transaction apparatus and the mobile device will not match. Accordingly, the individual will not be able to gain access to the user's transaction data.

Once the apparatus unique ID has been confirmed as illustrated in block 508, the user may be prompted to provide authentication data of the user. This authentication data may be in many forms, including, but not limited to biometric readers, such as finger prints, PINS, shape matching, passwords, passcodes, etc. The transaction apparatus may then receive the authentication data from the user, as illustrated in block 510. Once received, the transaction apparatus may compare the received authentication data to authentication data previously received and stored in the transaction apparatus. For example, a user may have previously stored finger print data as his/her authentication data. The finger print data may have been scanned via a biometric reader on the transaction apparatus and stored within the transaction apparatus. As such, when the user is attempting to utilize the transaction apparatus, he/she may present the same finger to the biometric scanner. If no match is determined, in some embodiments, the transaction apparatus, through the application may present emergency contacts for the user. In some embodiments, the transaction apparatus may lock the user out of the transaction apparatus such that he/she may not be able to access some or all the transaction data stored on the transaction apparatus. In yet other embodiments, the transaction apparatus may erase the data stored on the transaction apparatus upon failure of authentication.

If the transaction apparatus indicates that a match exists between the finger print of the user and the finger print previously stored, the user is authorized access to the entire application and the data stored on the transaction device as illustrated in block 512. At this point, a portion of the transaction data is allowed to be accessed and viewed by a user via his/her mobile device display utilizing the application or another program associated with the transaction apparatus. In some embodiments, only a portion of the transaction data is viewable by the user. For example, if a user provided credit card data to the transaction apparatus, such as via the magnetic strip reader, the user may now be presented with a representation of some or all the credit card data via the application. The representation may include information that would be found on a typical credit card, such as an account number, name associated with the account, type of card, etc. However, the transaction apparatus may have also stored additional data captured from the magnetic strip on the credit card. Data such as a Card Verification Value (CVV1) code may be captured to the transaction apparatus and a CVV2 code may be input by the user to the transaction apparatus, and the transaction apparatus may not divulge (or may not immediately divulge) the CVV1 code to the mobile device, application and/or user. In this way, certain information may be stored within the transaction apparatus and not communicated to a mobile device or the like.

The user may then select the output device to transfer the transaction data to. The transaction apparatus may then write the transaction data to the user output device based on user preferences, as illustrated in block 514. The transaction apparatus may write data to an output device including an E-ink display, a writable transaction card, wireless communication, etc. In some embodiments, the transaction data may be written to an E-ink display. The E-ink display may receive transaction data from the transaction apparatus formatted to fit on the E-ink display and be potentially used for a transaction. The E-ink display may display in color E-ink, grey scale E-ink, or the like. The E-ink may be used to display any data the user may request. As such, the user may utilize the E-ink display for not only transaction data, but any other data, communications, and/or functions of a mobile device and/or the transaction apparatus.

In some embodiments, the transaction data may be written to a writable transaction card. In some embodiments, the transaction data is written on to a writable transaction card through an Europay, MasterCard, Visa (EMV) chip on the writable transaction card. The processing device of the transaction apparatus may communicate to an EMV chip or the like associated with the writable transaction card. In some embodiments, the processing device of the transaction apparatus may communicate via contact communication with the writable transaction card. The transaction data written to the transaction card from the transaction apparatus may also include user preference data, such as track writing selection, time-out selection, etc. Track writing selection may allow one or more tracks associated with the writable transaction card to have data written onto it. In some embodiments, one track may store one set of transaction data while another track stores a second set of transaction data. In this way, a user may have two sets of transaction data on one writable transaction card. For example, a user may wish to use a gift card for a portion of a purchase of a product at a merchant. However, the user may only have a portion of the total purchase price of the product still remaining on the gift card. As such, the user may write one track on the transaction card with the gift card data and the second track with data associated with a credit card to pay the remaining balance for purchase of the product.

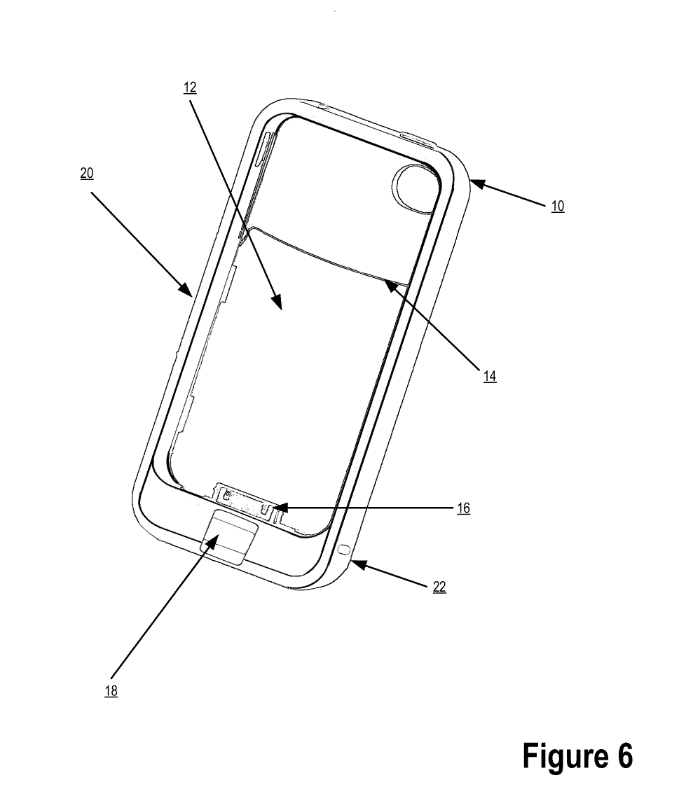

FIG. 6 illustrates a front view of one embodiment of the transaction apparatus. In this embodiment the transaction apparatus as a case associated with a mobile device. The transaction apparatus comprises and upper portion 10 and a lower portion 20. The upper portion 10 and the lower portion 20 are slide connected together, which forms a connection across the back portions of the case, as illustrated in section 14. In some embodiments of a transaction apparatus as a case for a mobile device, the transaction apparatus may be snapped together from front to back, top to bottom, or the like. In other embodiments of a transaction apparatus as a case for a mobile device, the transaction apparatus may be pliable such that the case may form around the mobile device. The inside of the transaction apparatus comprises a protective layer 12 for protecting the sides and back of the mobile device. In the embodiment illustrated in FIG. 6 the mobile device is hardwire connected 16 to the transaction apparatus. In this embodiment, a thirty-pin connector is used to hardwire connect the transaction apparatus to the transaction apparatus. Hardwire may also be done via USB connector, microphone connector, other wire connection, etc. Furthermore, the transaction apparatus may be wirelessly connected to the mobile device.

The transaction apparatus, in this embodiment, comprises a biometric reader 18 for user input and authorization. In some embodiments, the biometric reader may be integrated into the mobile device. In other embodiments, no biometric reader may be associated with the transaction apparatus or mobile device. Furthermore, the transaction apparatus may also include an aperture 22 for connection of user input and/or output devices.

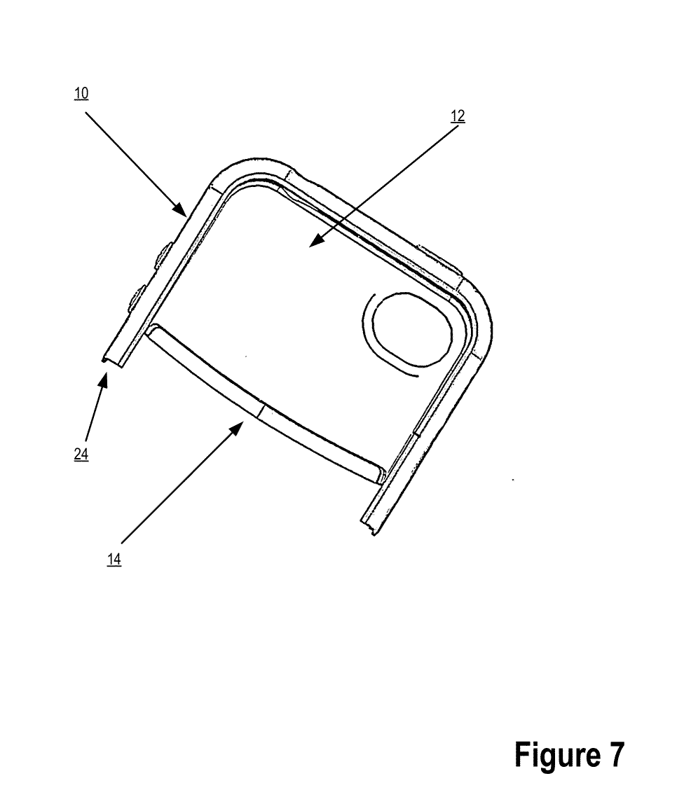

FIG. 7 illustrates a front view of the removable upper portion of the transaction apparatus as a case associated with a mobile device, in accordance with embodiments of the invention. The upper portion 10, in this embodiment, fits around the sides and back of a mobile device. The upper portion 10 includes depressions, apertures, indents, etc. that allow the mobile device to fit perfectly within the upper portion 10. The upper portion 10, like the lower portion 20 also has a protective layer 12 to protect the back and sides of the mobile device. Furthermore, the upper portion 10 slides to fit the lower portion 20 with a slide connection. The slide connection is secured by an interlocking type connection at the connection site 24 at the side of the upper portion 10.

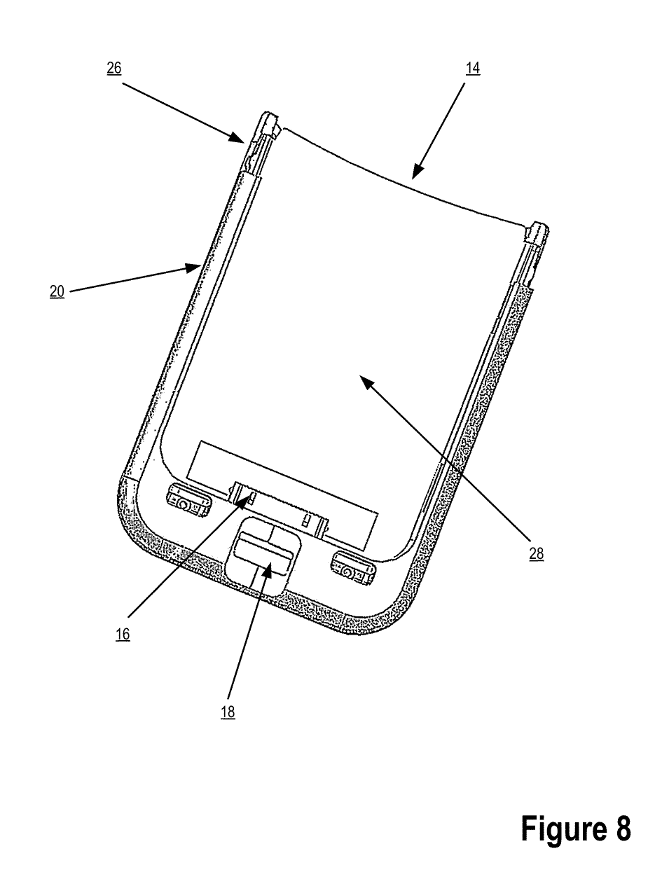

FIG. 8 illustrates a front view of one embodiment of the lower portion of the transaction apparatus as a case associated with a mobile device, in accordance with embodiments of the invention. The lower portion 20, in this embodiment, fits around the sides and back of a mobile device. The lower portion 20, like the upper portion 10, includes depressions, apertures, indents, etc. that allow the mobile device to fit perfectly within the lower portion 20. The lower portion 20 also comprises the biometric reader 18 and an aperture 22 for connection of user input and/or output devices. Furthermore, the lower portion 20 comprises, in some embodiments, the hardwire connection 16, as illustrated in the thirty-pin connector depicted in FIG. 8. The mobile device slides into position and connects to the hardwire connection 16 for a connection between the mobile device and the transaction apparatus to be initiated. In some embodiments, this connection may be a wireless connection, touch connection, contact connection, and/or the like. Once the mobile device is in position, the upper portion 10 may slide down the mobile device to fit the lower portion 20. The slide connection is secured by an interlocking type connection at the connection site 26 on the lower portion 20 that corresponds to the connection site 24 at the side of the upper portion 10.

The illustration depicted in FIG. 8 has the protective layer 12 removed to illustrate the mobile device back protection layer 28. The mobile device back protection layer 28 provides a physical separation between the mobile device and the writable transaction card. In this way the mobile device back protection layer 28 forms a portion of the writable transaction card sleeve.

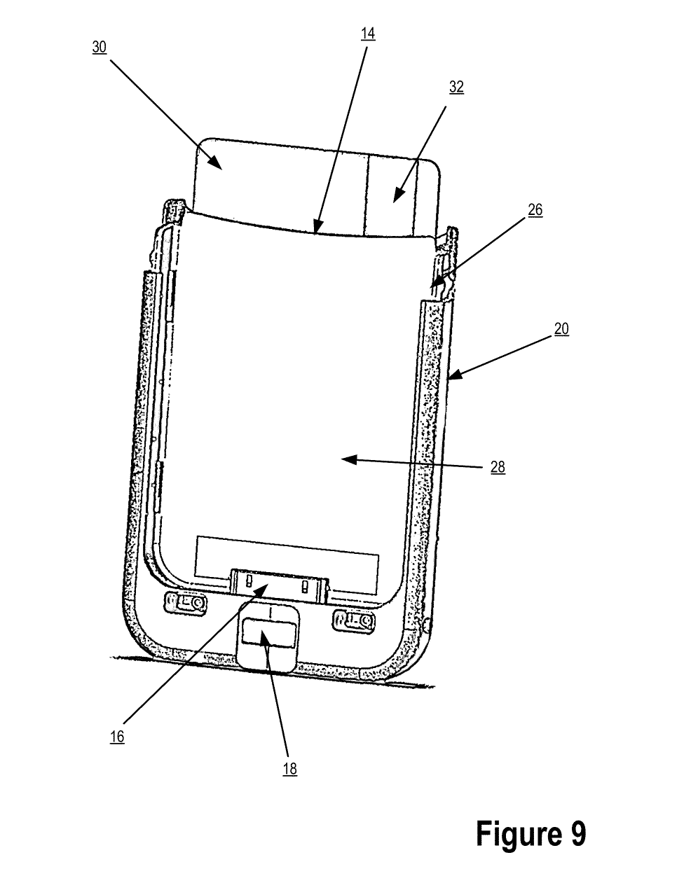

FIG. 9 illustrates a front view of one embodiment of the lower portion of the transaction apparatus as a case associated with a mobile device with the writable transaction card, in accordance with embodiments of the invention. This is similar to the illustration depicted in FIG. 8, however, in this illustration the writable transaction card 30 is secured in the writable transaction card sleeve. The writable transaction card 30 also comprises strip 32, such that it may act like a magnetic card when necessary.

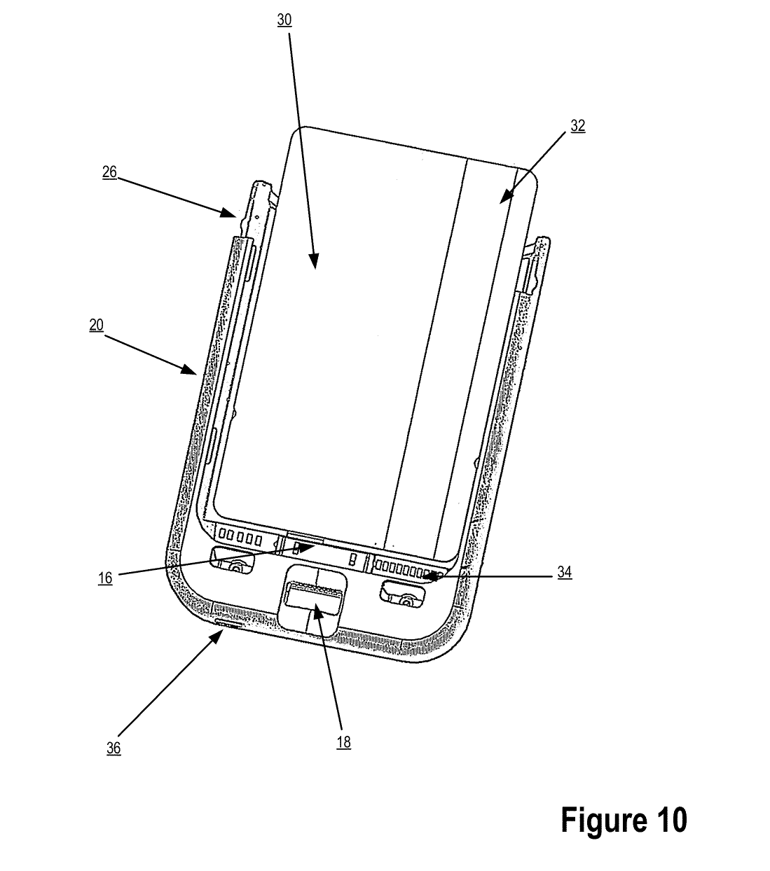

FIG. 10 illustrates a front view of one embodiment of the lower portion of the transaction apparatus as a case associated with a mobile device with the mobile device back protector hidden, in accordance with embodiments of the invention. With the mobile device back protection layer 28 removed, the entire writable transaction card 30 is exposed. In this way, with the mobile device back protection layer 28 removed, a portion of the transaction apparatus board 34 may be seen. Furthermore this illustration reveals and input device aperture 36 on the transaction apparatus. In this embodiment, the input device 36 is a micro-USB port.

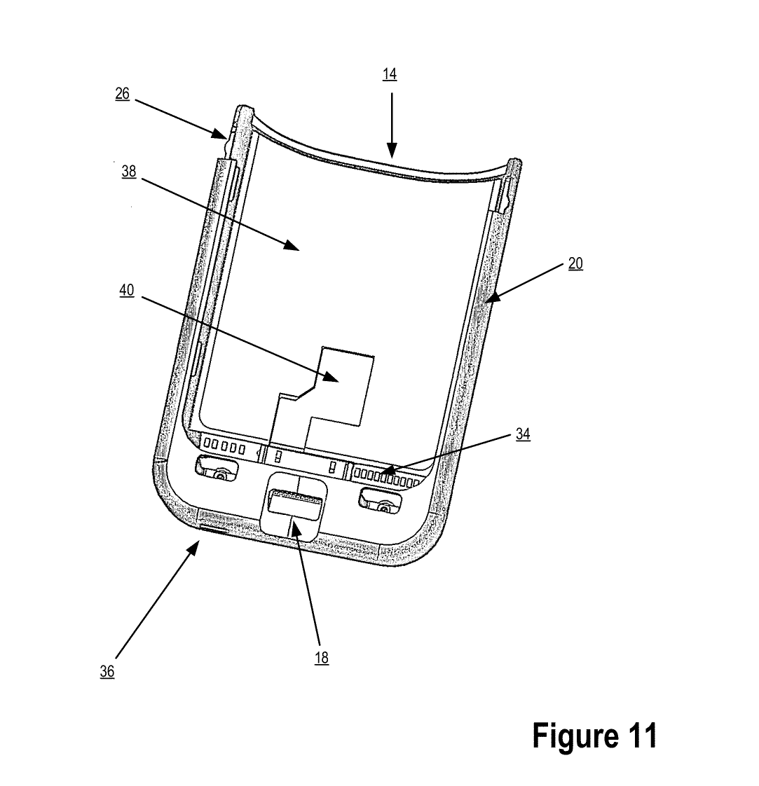

FIG. 11 illustrates a front view of one embodiment of the lower portion of the transaction apparatus as a case associated with a mobile device exposing a transaction card data transfer aperture, in accordance with embodiments of the invention. In FIG. 11 the writable transaction card 30 has been removed to expose the transaction apparatus system protective layer 38. The transaction apparatus system protective layer 38 protects at least some of the system components of the transaction apparatus from the writable transaction card 30 and the mobile device. Furthermore, the transaction apparatus system protection layer 38 forms another side to the writable transaction card 30 sleeve. The transaction apparatus system protection layer 38 further comprises a transaction card data transfer aperture 40 for contact transfer of transaction data from the transaction apparatus to the writable transaction card 30.

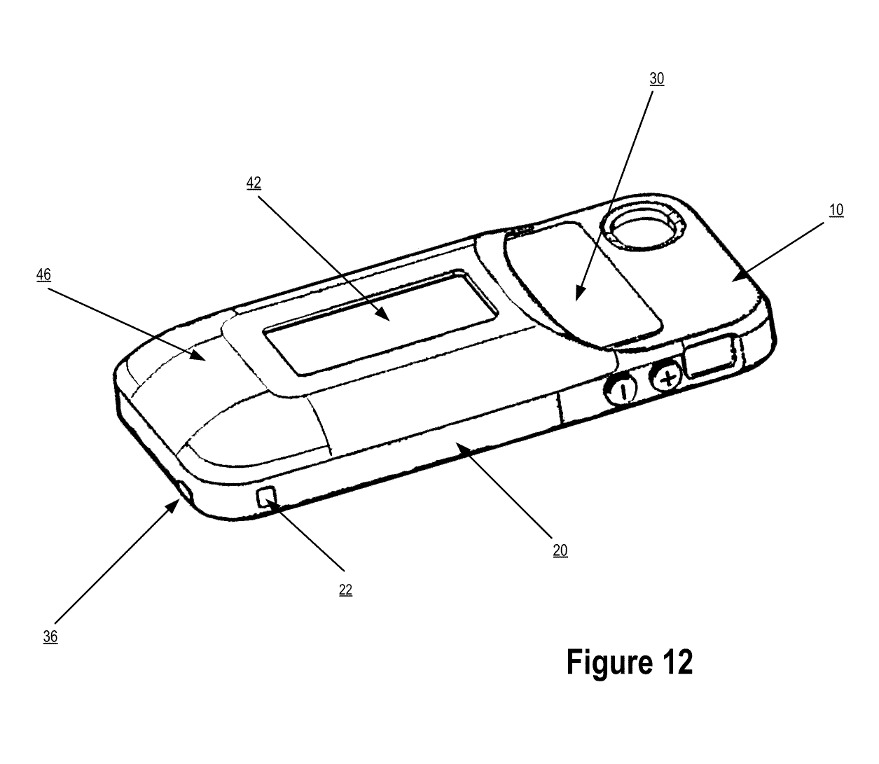

FIG. 12 illustrates a rear view of one embodiment of the transaction apparatus as a case associated with a mobile device, in accordance with embodiments of the invention. FIG. 12 depicts an input device aperture 36, an aperture 22 for connection of user input and/or output devices, the writable transaction card 30 within the writable transaction card sleeve, the upper portion 10 of the transaction apparatus, a lower portion of the apparatus 20, the back housing 46 of the transaction apparatus, and an E-ink display 42.

As illustrated in FIG. 12, the E-ink display 42 is located, in this embodiment, on the back of the transaction apparatus within the back housing 46. In some embodiments, the E-ink display 42 may display transaction data from the transaction apparatus. Furthermore, the E-ink display 42 may display advertisements, micro-bulletin boards, skew numbers, apparatus ID, etc. In some embodiments, the E-ink display 42 may display data from the mobile device. For example, the E-ink display 42 may display text messages, emails, games, stock quotes, to-do lists, other lists, indicators of voice mails, etc. In this way, the user may be able to select data that the mobile device may automatically provide to the E-ink display 42. For example, a user may be using a cellular phone as his/her mobile device. The user may select for the mobile device to communication with the transaction apparatus to present incoming text messages on the E-ink display 42. In this way, every time the user receives a new text message it may be automatically presented on the E-ink display 42. As such, the user may not have to wake-up or power up his/her mobile device, authenticate himself/herself with the mobile device and select the application associated with text messages in order to view a text message. As illustrated in FIG. 12, the user may simply view the E-ink display 42 located on the rear portion of the transaction apparatus within the back housing 46. In yet other embodiments, the E-ink display 42 may display data from the Internet, a wireless connection, a second transaction apparatus, etc. In some embodiments, the E-ink display 42 may display images in color. In some embodiments, the E-ink display 42 may display images in grey scale.

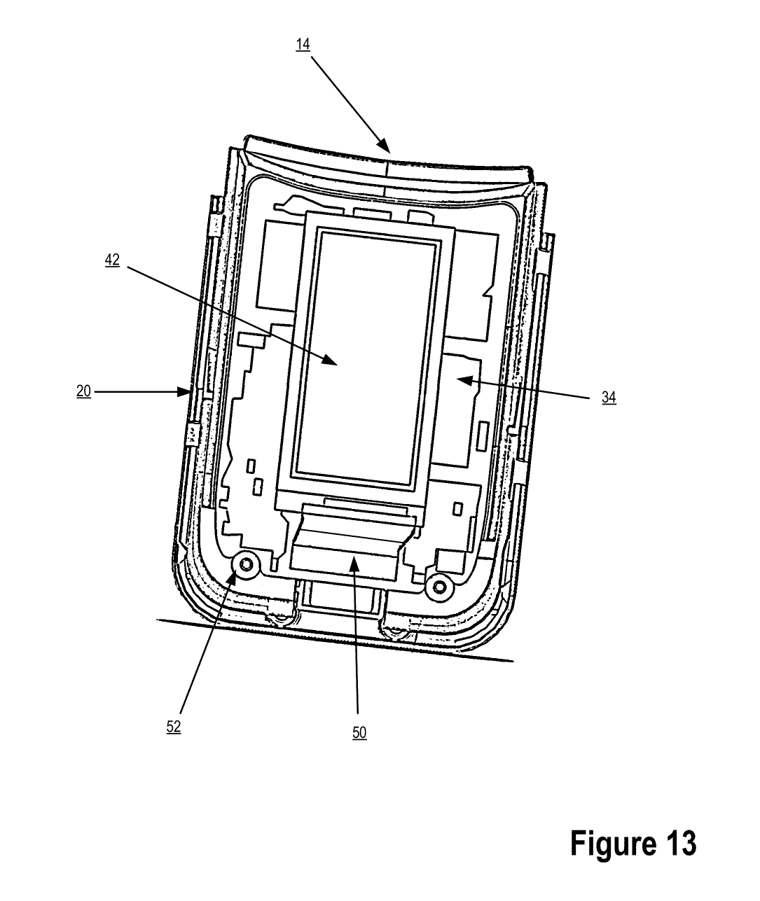

FIG. 13 provides an illustration of a rear view of one embodiment of the transaction apparatus as a case associated with a mobile device with an E-ink display exposed, in accordance with embodiments of the invention. In this embodiment, the back housing 46 is removed showing the E-ink display 42. Removing the back housing 46 also exposes the back portion of the transaction apparatus board 34 and a Flat Circuit Connector (FCC) connector or the like 50 that connects the components of the transaction apparatus board 34 with the E-ink display. In yet other embodiments, a similar FFC connector or the like may connect the mobile device to the components of the transaction apparatus board 34.

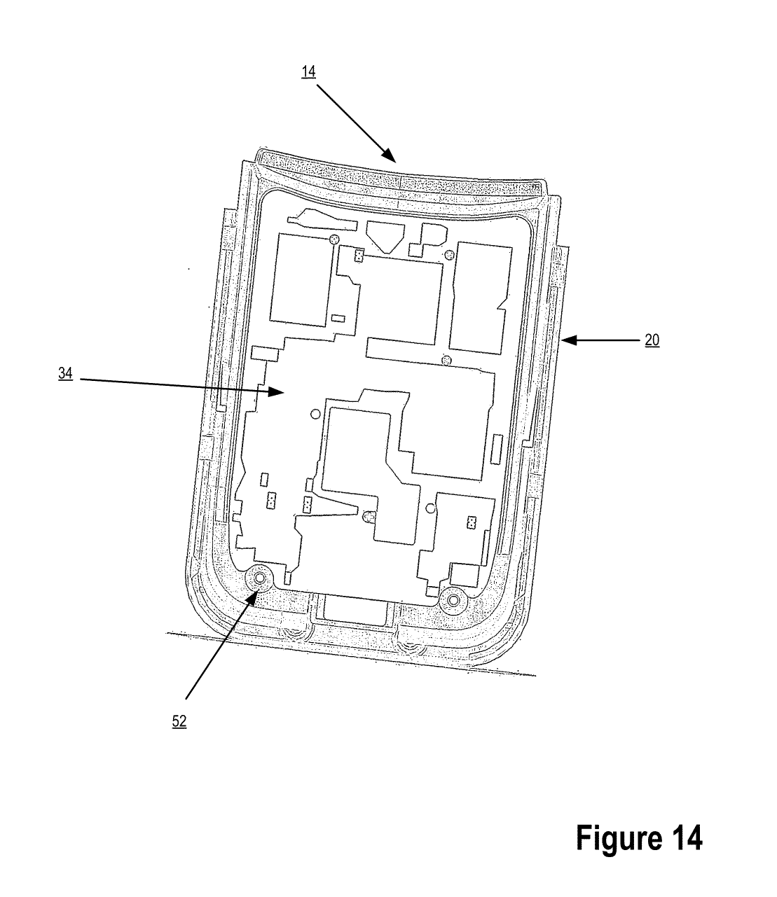

FIG. 14 illustrates a rear view of one embodiment of the transaction apparatus as a case associated with a mobile device with the transaction apparatus board exposed, in accordance with embodiments of the invention. As illustrated in FIG. 14 the E-ink display 42 is removed and the entire transaction apparatus board 34 is exposed. Also exposed are screws 52 that secure the various components of the lower portion 20 of the transaction apparatus together.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational phases to be performed on the computer or other programmable apparatus to produce a computer-implemented process such that the code portions which execute on the computer or other programmable apparatus provide phases for implementing the functions/acts specified in the flowchart and/or block diagram block(s). Alternatively, computer program implemented phases or acts may be combined with operator or human implemented phases or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices, which may or may not be coupled to one another. Likewise, where a memory is illustrated or described herein, the memory may be made up of a plurality of memory devices, which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system comprising:
a memory device;
an output device; and
a processing device operatively coupled to the memory device and the output device, wherein the processing device is configured to execute computer-readable program code to:
receive transaction data, wherein the transaction data comprises financial, identification, or personal data associated with a user;
store the received transaction data in the memory device;
authorize communication between the system and an application;
receive, from the user, an indication that the user wishes to enter into a transaction using the transaction data stored in the memory device;
communicate the transaction data the user wishes to use to enter into a transaction to an output device for use during a transaction; and
communicate in association with the transaction data, preferences associated with the transaction data communicated to the output device.

2. The system of claim 1, wherein the memory device, output device, and processing device are associated with a transaction device that is a case configured for communicating with a mobile device.

3. The system of claim 1 further comprising encrypting the received transaction data prior to storing the data within the memory device.

4. The system of claim 1 wherein the indication received from the user is received from a mobile device in communication with the transaction device.

5. The system of claim 1 wherein the output device includes one or more of:
an E-ink display, wherein the E-ink display presents transaction data on the transaction device; and
a writable transaction card, wherein the writable transaction card capable of being processed via a magnetic strip reader for a transaction.

6. A computer program product comprising at least one non-transitory computer-readable medium having computer-readable program code portions embodied therein, the computer-readable program code portions comprising:
an executable portion configured for receiving transaction data, wherein the transaction data comprises financial, identification, or personal data associated with a user;
an executable portion configured for storing the received transaction data in the memory device;
an executable portion configured for authorizing communication between the system and an application;
an executable portion configured for receiving, from the user, an indication that the user wishes to enter into a transaction;
an executable portion configured for communicate one or more transaction data that the user wishes to use to enter into a transaction to an output device for use during a transaction; and
an executable portion configured for communicating in association with the transaction data, preferences associated with the transaction data communicated to the output device.

7. The computer program product of claim 6, wherein the memory device, output device, and processing device are associated with a transaction device that is a case configured for communicating with a mobile device.

8. The computer program product of claim 6 further comprising an executable portion configured for encrypting the received transaction data prior to storing the data within the memory device.

9. The computer program product of claim 6 wherein the indication received from the user is received from a mobile device in communication with the transaction device.

10. The computer program product of claim 6 wherein the output device includes one or more of:
an E-ink display, wherein the E-ink display presents transaction data on the transaction device; and
a writable transaction card, wherein the writable transaction card capable of being processed via a magnetic strip reader for a transaction.

11. A method comprising:
receiving transaction data, wherein the transaction data comprises financial, identification, or personal data associated with a user;
storing the received transaction data in the memory device;
authorizing communication between the system and an application;
receiving, from the user, an indication that the user wishes to enter into a transaction using the transaction data stored in the memory device;
communicating the transaction data the user wishes to use to enter into a transaction to an output device for use during a transaction; and
communicating in association with the transaction data, preferences associated with the transaction data communicated to the output device.

12. The method of claim 11, wherein the memory device, output device, and processing device are associated with a transaction device that is a case configured for communicating with a mobile device.

13. The method of claim 11 further comprising encrypting the received transaction data prior to storing the data within the memory device.

14. The method of claim 11 wherein the indication received from the user is received from a mobile device in communication with the transaction device.

15. The method of claim 11 wherein the output device includes one or more of:
an E-ink display, wherein the E-ink display presents transaction data on the transaction device; and
a writable transaction card, wherein the writable transaction card capable of being processed via a magnetic strip reader for a transaction.
